(19) United States
(12) Patent Application Publication
(10) Pub. No.: US 2015/0242064 A1
(43) Pub. Date: Aug. 27, 2015

(54) INFORMATION DISPLAY APPARATUS THAT DISPLAYS DOCUMENT PAGE

(71) Applicant: TOSHIBA TEC KABUSHIKI KAISHA, Tokyo (JP)

(72) Inventors: Yusuke HAMADA, Mishima Shizuoka (JP); Hiroshi WATANABE, Yokohama Kanagawa (JP); Akihiro MIZUTANI, Mishima Shizuoka (JP); Takahiro HAGIWARA, Chiba Chiba (JP); Shinji MAKISHIMA, Suntou Shizuoka (JP); Toshihiro IDA, Mishima Shizuoka (JP); Ken SAKUTA, Izunokuni Shizuoka (JP)

(21) Appl. No.: 14/626,807

(22) Filed: Feb. 19, 2015

(30) Foreign Application Priority Data
Feb. 21, 2014 (JP) 2014-032060

(51) Int. Cl. G06F 3/0481; G06F 3/0484

(52) U.S. Cl. CPC G06F 3/0481; G06F 3/04842; G06F 3/04845

(57) ABSTRACT

An information display apparatus includes a display unit and a control unit. The display unit is configured to display a document page with a plurality of layers superimposed thereon. The plurality of layers includes a first layer that includes a first image that is accessible by the information display apparatus and not by an apparatus external to the information display apparatus, and a second layer that includes a second image that is accessible by the information display apparatus and the apparatus external to the information display apparatus. The control unit is configured to set one of the plurality of layers as a writing layer in which a user can add an image, and control the display unit such that a density of the first image is different from a density of the second image when the first layer is set as the writing layer.

### CROSS-REFERENCE TO RELATED APPLICATION

This application is based upon and claims the benefit of priority from Japanese Patent Application No. 2014-032060, filed Feb. 21, 2014, the entire contents of which are incorporated herein by reference.

### FIELD

Embodiments described herein relate generally to an information display apparatus that displays a document page with a plurality of layers superimposed thereon.

### BACKGROUND

One type of an information display apparatus such as a tablet PC displays a document page with a plurality of image layers superimposed thereon. When one of the image layers is selected, a user can add an image in the selected image layer, and the added image is displayed with the document page. These image layers include an image layer to be displayed only on a local device and a shared image layer that is to be displayed on any device having access to the document page. It would be desirable for the user to be able to easily distinguish between these different types of image layers.

### DESCRIPTION OF THE DRAWINGS

FIG. 1 is a block diagram of a drawing data management system according to an embodiment.

FIG. 2 is a block diagram of a drawing data management server in the system according to the embodiment.

FIG. 3 is a block diagram of a user terminal in the system according to the embodiment.

FIG. 4 is a flowchart illustrating an operation carried out by the user terminal.

### DETAILED DESCRIPTION

One or more embodiments provide an information browsing apparatus that displays an image of a writing layer and an image of another layer so as to be easily distinguished, and an information browsing program.

In general, according to one embodiment, an information display apparatus includes a display unit and a control unit. The display unit is configured to display a document page with a plurality of layers superimposed thereon. The plurality of layers includes a first layer that includes a first image that is accessible by the information display apparatus and not by an apparatus external to the information display apparatus, and a second layer that includes a second image that is accessible by the information display apparatus and the apparatus external to the information display apparatus. The control unit is configured to set one of the plurality of layers as a writing layer in which a user can add an image, and control the display unit such that a density of the first image is different from a density of the second image when the first layer is set as the writing layer.

Hereinafter, an embodiment will be described with reference to the accompanying drawings.

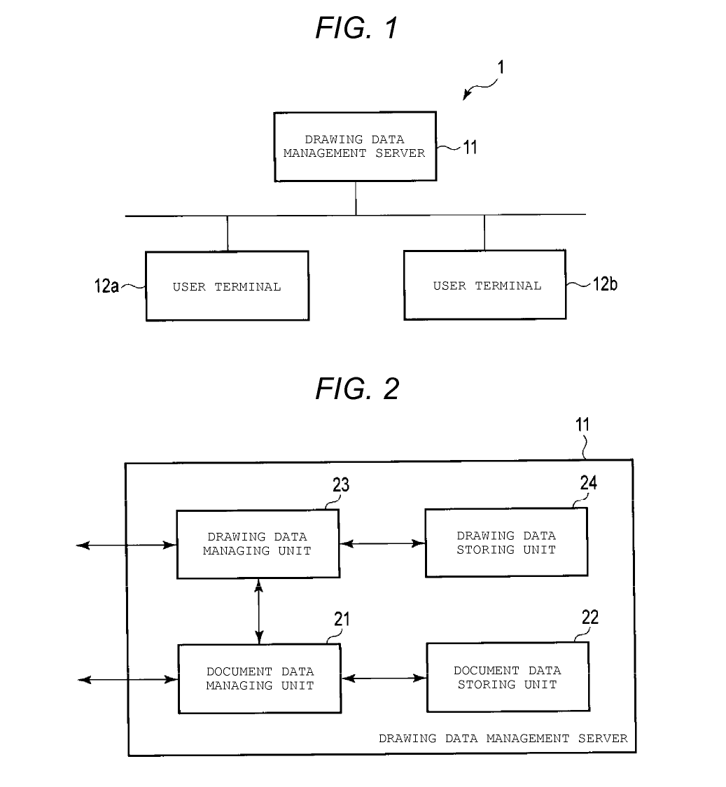

FIG. 1 is a block diagram of a drawing data management system 1 according to an embodiment.

The drawing data management system 1 is a system that manages document data of a document, and drawing data indicating an image written on each page of the document.

In the drawing data management system 1, the document can be browsed through a user terminal 12. Further, in the drawing data management system 1, the image corresponding to the drawing data can be browsed through the user terminal 12.

As illustrated in FIG. 1, the drawing data management system 1 includes a drawing data management server 11, a user terminal 12a, a user terminal 12b, and the like.

The drawing data management server 11 stores document data to be transmitted to the user terminal 12. The drawing data management server 11 transmits the document data to the user terminal 12.

Further, the drawing data management server 11 receives drawing data indicating the image written to the page of the document by the user from the user terminal 12. The drawing data management server 11 stores the received drawing data. The drawing data management server 11 transmits the drawing data to the user terminal 12 that transmits the drawing data. In addition, in the drawing data management system 1, the user terminal 12 may transmit drawing data received from another user terminal 12.

The drawing data management server 11 is a PC or the like, for example. The drawing data management server 11 will be described in detail below.

Since the user terminals 12a and 12b have the same configuration, hereinafter, the description will be made to the user terminal 12.

The user terminal 12 requests the document data from the drawing data management server 11 according to a user's instruction. Then, the user terminal 12 acquires the document data transmitted according to the request from the drawing data management server 11, and displays each page of the document corresponding to the document data to the user.

Further, the user terminal 12 requests the drawing data from the drawing data management server 11, according to an instruction of the user. The user terminal 12 acquires the drawing data transmitted according to the request from the drawing data management server 11. The user terminal 12 adds an image indicated by the drawing data to a page corresponding to the acquired drawing data, and displays the document page and the image to the user.

The user terminal 12 may be a tablet PC, a smart phone, a notebook PC, or the like. The user terminal 12 will be described in detail below.

In the example illustrated in FIG. 1, the drawing data management system 1 includes two user terminals 12 of the user terminals 12a and 12b. The drawing data management system 1 may include one user terminal 12, or three or more user terminals 12. The number of user terminals 12 included in the drawing data management system 1 is not limited to a specific number. Further, the user terminal 12 is an information browsing apparatus.

Next, the drawing data management server 11 will be described in detail. FIG. 2 is a block diagram of the drawing data management server 11. As illustrated in FIG. 2, the drawing data management server 11 includes a document data managing unit 21, a document data storing unit 22, a drawing data managing unit 23, a drawing data storing unit 24, or the like.

The document data managing unit 21 manages document data stored in the document data storing unit 22. The document data managing unit 21 receives the document data from a user who inputs the document data through a PC or the like. The document data managing unit 21 stores the received document data in the document data storing unit 22.

Further, the document data managing unit 21 transmits the document data stored in the document data storing unit 22 to the user terminal 12 according to the request from the user terminal 12. The document data managing unit 21 may transmit the document data stored in the document data storing unit 22 to the user terminal 12 at a predetermined timing or based on an instruction of a user of the drawing data management server 11.

The document data storing unit 22 stores the document data to be transmitted to the user terminal 12. The document data storing unit 22 may be caused to store the document data by the document data managing unit 21. Further, the document data storing unit 22 may store the document data during manufacturing process of the drawing data management server 11 or the like.

The drawing data managing unit 23 manages drawing data. The drawing data includes information indicating an image written to a page through the user terminal 12 by the user, and information indicating the page number.

The drawing data managing unit 23 receives the drawing data from the user terminal 12, and stores the received drawing data in the drawing data storing unit 24.

When the user performs writing of an image on a page for private browsing through the user terminal 12 (private writing), the user terminal 12 transmits drawing data indicating the written image to the drawing data management server 11 as private drawing data. The drawing data managing unit 23 stores the received drawing data in the drawing data storing unit 24 as the private drawing data.

Further, when the user performs writing of an image on a page for sharing with another user through the user terminal 12 (shared writing), the user terminal 12 transmits drawing data indicating the written image to the drawing data management server 11 as shared drawing data. The drawing data managing unit 23 stores the received drawing data in the drawing data storing unit 24 as the shared drawing data.

In order to distinguish between the shared drawing data and the private drawing data, the user terminal 12 assigns attribute information indicating a layer of the drawing data to the drawing data, and transmits both the drawing data and the attribute information to the drawing data management server 11. Here, the layer is a layer corresponding to the shared drawing data or a layer corresponding to the private drawing data. The attribute information indicates whether the drawing data is the shared drawing data or the private drawing data.

The drawing data managing unit 23 transmits the drawing data stored in the drawing data storing unit 24 to the user terminal 12 according to a request from the user terminal 12. The drawing data managing unit 23 may transmit the drawing data stored in the drawing data storing unit 24 to the user terminal 12 at a predetermined timing or based on an instruction of a user of the drawing data management server 11.

The drawing data managing unit 23 transmits drawing data capable of being browsed through the user terminal 12 to the user terminal 12. For example, the drawing data managing unit 23 transmits the private drawing data received from the user terminal 12 to the user terminal 12. Further, the drawing data managing unit 23 transmits the shared drawing data to the user terminal 12.

The drawing data management server 11 includes a CPU, a RAM, a ROM, a nonvolatile memory, a communication interface, an operation unit, a display unit, and the like.

The CPU has a function of controlling an overall operation of the drawing data management server 11. The CPU may include an internal cache, various interfaces, and the like. The CPU performs various processes by developing on the RAM a program stored in advance in an internal memory, the ROM, or the nonvolatile memory and executing the program.

The RAM is a volatile memory. The RAM temporarily stores data or the like that is processed by the CPU. The RAM stores various application programs based on commands from the CPU. Further, the RAM may store data necessary for execution of an application program, an execution result of the application program, or the like.

The ROM is a nonvolatile memory in which a control program, control data, and the like are stored in advance. The control program and the control data stored in the ROM are incorporated in advance according to specification of the drawing data management server 11. For example, the ROM stores a program (for example, BIOS) for controlling a circuit board of the drawing data management server 11, or the like.

The nonvolatile memory is capable of performing data writing or data rewriting. The nonvolatile memory includes a hard disk, an SSD, an EEPROM, a flash memory or the like, for example. The nonvolatile memory stores a control program, an application, and various data according to use of the drawing data management server 11.

The communication interface is an interface for communication with the user terminal 12 or the like in a wired or wireless manner. The communication interface transmits various data to the user terminal 12 based on commands from the CPU. Further, the communication interface receives various data from the user terminal 12. For example, the communication interface may be an interface that is locally connected to the user terminal 12, or may be an interface for communication with the user terminal 12 through a communication network such as the Internet.

The operation unit receives various operations by an administrator or the like of the drawing data management server 11. For example, the operation unit corresponds to a keyboard, a mouse, a touch panel or the like.

The display unit displays various kinds of information to the administrator or the like of the drawing data management server 11. For example, the display unit is a liquid crystal display or the like.

The document data managing unit 21 and the drawing data managing unit 23 are achieved by executing a computer program on the RAM and controlling the communication interface by the CPU.

Further, the document data storing unit 22 and the drawing data storing unit 24 are achieved by a nonvolatile memory.

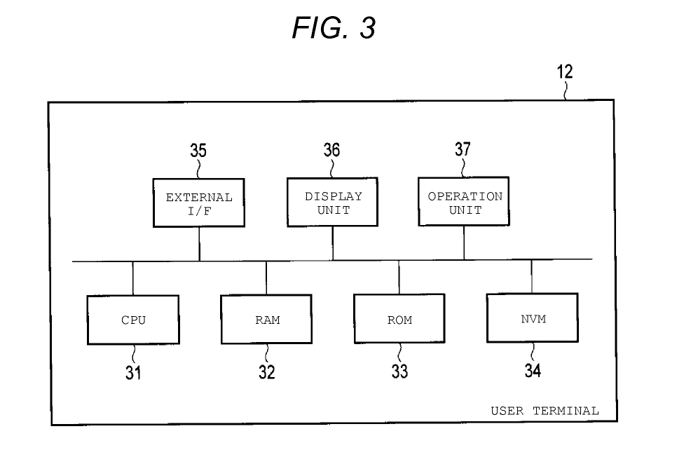

Next, the user terminal 12 will be described. FIG. 3 is a block diagram of the user terminal 12. As illustrated in FIG. 3, the user terminal 12 includes a CPU 31, a RAM 32, a ROM 33, an NVM 34, an external interface 35, a display unit 36, an operation unit 37, and the like.

The CPU 31 has a function of controlling an overall operation of the user terminal 12. The CPU 31 may include an internal cache, various interfaces, and the like. The CPU 31 performs various processes by developing on the RAM 32 a program stored in advance in an internal memory, the ROM 33, or the NVM 34 and executing the program.

The RAM 32 is a volatile memory. The RAM 32 temporarily stores data or the like that is processed by the CPU 31. The RAM 32 stores various application programs based on commands from the CPU 31. Further, the RAM 32 may store data necessary for execution of the application program, an execution result of the application program, or the like.

The ROM 33 is a nonvolatile memory in which a control program, control data and the like are stored in advance. The control program and the control data stored in the ROM 33 are incorporated in advance according to specification of the user terminal 12. For example, the ROM 33 stores a program (for example, BIOS) for controlling a circuit board of the user terminal 12, or the like.

The NVM 34 is a nonvolatile memory capable of performing data writing or data rewriting. The NVM 34 includes a hard disk, an SSD, an EEPROM, a flash memory or the like, for example. The nonvolatile memory stores a control program, an application, and various data according to use of the user terminal 12.

The external interface 35 is an interface for communication with the drawing data management server 11 or the like in a wired or wireless manner. The external interface 35 transmits various data to the drawing data management server 11 based on commands from the CPU 31. Further, the external interface 35 receives various data from the drawing data management server 11. For example, the external interface 35 may be an interface that is locally connected to the drawing data management server 11, or may be an interface for communication with the drawing data management server through a communication network such as the Internet.

The display unit 36 displays various kinds of information to the user terminal 12. The display unit 36 displays a page of a document and a written image corresponding to the page, based on an instruction from the CPU 31. For example, the display unit is a liquid crystal display or the like.

The operation unit 37 receives various operations by the user of the user terminal 12. The operation unit 37 receives writing of an image on a page. Further, the operation unit 37 receives setting of a browsing mode and a writing layer. The browsing mode and the writing layer will be described below. For example, the operation unit is a keyboard, a mouse, a touch panel, or the like.

The display unit 36 and the operation unit 37 may be integrally formed.

Next, an operation example of the drawing data management system 1 will be described. Here, it is assumed that the drawing data management server 11 stores document data to be distributed to the user terminal 12 in the document data storing unit 22. Further, it is assumed that the drawing data management server 11 stores the private drawing data and the shared drawing data in the drawing data storing unit 24.

The user terminal 12 requests the document data capable of being browsed through the user terminal 12 from the drawing data management server 11.

The drawing data management server 11 transmits the document data capable of being browsed through the user terminal 12 to the user terminal 12 according to the request from the user terminal 12.

The user terminal 12 receives the document data from the drawing data management server 11. If the document data is received from the drawing data management server 11, the user terminal 12 displays a page of the document corresponding to the document data on the display unit 36.

If the page of the document is displayed, the user terminal 12 can request the drawing data from the drawing data management server 11.

The drawing data management server 11 transmits the private drawing data and the shared drawing data, which are capable of being browsed through the user terminal 12, to the user terminal 12 according to the request from the user terminal 12. Here, the private drawing data is drawing data indicating an image written through the user terminal 12. The private drawing data may be private drawing data corresponding to a user who performs login using the same ID.

The user terminal 12 receives the private drawing data and the shared drawing data from the drawing data management server 11. If the private drawing data and the shared drawing data are received, the user terminal 12 displays the image indicated by the private drawing data and/or the image indicated by the shared drawing data, which are corresponding to a page of the document data, on the page according to a browsing mode.

The browsing mode corresponds to the drawing data to be displayed on a page of the document by the user terminal 12. Here, the browsing mode is any one of “private note,” “shared board,” and “private+shared.”

The “private note” represents a browsing mode in which the user terminal 12 displays the image indicated by the private drawing data on the page of the document. That is, when the browsing mode is the “private note,” the user terminal 12 displays the image written as private writing through the user terminal 12 by the user, on the page of the document.

The “shared board” represents a browsing mode in which the user terminal 12 displays the image indicated by the shared drawing data on the page of the document. That is, when the browsing mode is the “shared board,” the user terminal 12 displays the image written as shared writing through each user terminal 12 by each user, on the page of the document.

The “private+shared” represents a browsing mode in which the user terminal 12 displays the images indicated by both the private drawing data and the image indicated by the shared drawing data on the page of the document. That is, when the browsing mode is the “private+shared,” the user terminal 12 displays the image written as private drawing through the user terminal 12 by the user and the image written as shared drawing through each user terminal 12 by each user, on the page of the document.

The user terminal 12 receives selection of the browsing mode through the operation unit 37 by the user. For example, the user terminal 12 may display an icon for selection of the browsing mode on the display unit 36, and may receive a touch of the icon by the user.

The user terminal 12 may receive selection of the browsing mode in advance. Further, the user terminal 12 may receive change of the browsing mode while the page of the document is displayed.

Here, it is assumed that the browsing mode of the user terminal 12 is set to “private+shared.”

After the image is displayed on the page of the document according to the browsing mode, the user terminal 12 may receive another image written in the writing layer through the operation unit 37.

The writing layer is a layer in which the user of the user terminal 12 can performs writing of an image on the page of the document. The writing layer is one of “private layer” and “shared layer.”

The user terminal 12 transmits drawing data indicating an image written in the writing layer and attribution information (first attribution information) indicating the writing layer, to the drawing data management server 11, in correlation.

The “private layer” is a layer in which the user of the user terminal 12 performs the private writing. When the writing layer is set to “private layer,” the user terminal 12 transmits the drawing data indicating the image written by the user to the drawing data management server 11 as the private drawing data.

The “shared layer” is a layer in which the user of the user terminal 12 performs the shared writing. When the writing layer is set to “shared layer,” the user terminal 12 transmits the drawing data indicating the image written by the user to the drawing data management server 11 as the shared drawing data.

Further, the user terminal 12 sets a high density (first density) (or a low transmittance) with respect to drawing data corresponding to the writing layer, and sets a low density (second density) (or a high transmittance) with respect to drawing data corresponding to the other layer.

For example, when the writing layer is set to “private layer,” the user terminal 12 sets the first density for the drawing data (that is, private drawing data) corresponding to “private layer.” That is, the user terminal 12 displays the image indicated by the private drawing data with a higher density.

On the other hand, when the writing layer is set to “private layer,” the user terminal 12 sets the second density for the drawing data (that is, shared drawing data) corresponding to “shared layer,” That is, the user terminal 12 displays the image indicated by the shared drawing data with a lower density.

Further, when the writing layer is set to “shared layer,” the user terminal 12 sets the first density for the drawing data (that is, shared drawing data) corresponding to “shared layer.” That is, the user terminal 12 displays the image indicated by the shared drawing data with a higher density.

On the other hand, when the writing layer is set to “shared layer,” the user terminal 12 sets the second density for the drawing data (that is, private drawing data) corresponding to “private layer.” That is, the user terminal 12 displays the image indicated by the private drawing data with a lower density.

For example, the user terminal 12 may set the density of the image indicated by the drawing data corresponding to the writing layer to 100% as the first density (or 0% of transmittance). Further, the user terminal 12 may set the density of the image indicated by the drawing data corresponding to the other layer to 50% as the second density (or 50% of transmittance).

The density of the display of the image indicated by each type of drawing data, set by the user terminal 12, is not limited to a specific configuration.

The writing layer may be selected from another layer. The configuration of the writing layer is not limited to a specific configuration.

The user terminal 12 may limit a writable writing layer. For example, writing of images on the shared layer may be limited on a predetermined user terminal 12.

On the user terminal 12, the writing layer may be limited based on a signal from the drawing data management server 11.

If the image written on the writing layer is received, the user terminal 12 transmits drawing data indicating the image to the drawing data management server 11 as the private or shared drawing data, according to the type of the writing layer.

The drawing data managing unit 23 of the drawing data management server 11 receives the private or shared drawing data. If the private or shared drawing data is received, the drawing data managing unit 23 stores the received private or shared drawing data in the drawing data storing unit 24.

When the shared drawing data is stored in the drawing data storing unit 24, the drawing data managing unit 23 of the drawing data management server 11 may transmit the stored shared drawing data to another user terminal 12.

If the shared drawing data is received, the user terminal 12 displays the image indicated by the received shared drawing data on the page of the document.

After the user terminal 12 displays the image indicated by the shared drawing data, the drawing data management system 1 terminates the operation.

The drawing data management system. 1 manages the drawing data by repeating the operation as necessary.

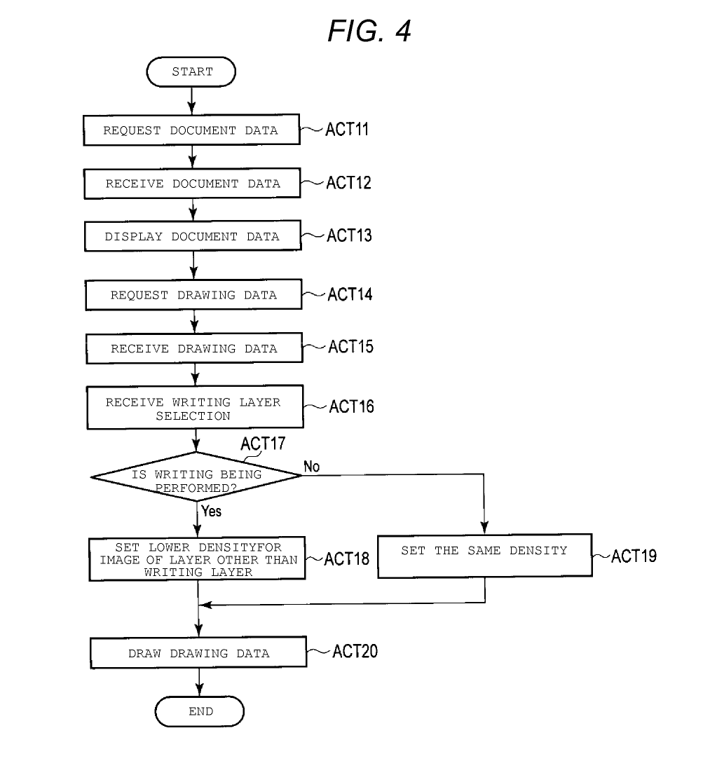

Next, an operation example in which the user terminal 12 displays a page of a document and an image indicated by drawing data will be described. FIG. 4 is a flowchart illustrating an operation during which the user terminal 12 displays the page of the document and the image indicated by the drawing data.

Here, it is assumed that the browsing mode of the user terminal 12 is set to “private+shared.”

First, the CPU 31 of the user terminal 12 requests document data from the drawing data management server 11 through the external interface 35 (ACT 11).

After requesting the document data, the CPU 31 receives the document data from the drawing data management server 11 through the external interface 35 (ACT 12).

If the document data is received, the CPU 31 displays a predetermined page of the document on the display unit 36 (ACT 13).

If the predetermined page of the document is displayed, the CPU 31 requests the private drawing data and the shared drawing data from the drawing data management server 11 through the external interface 35 (ACT 14).

After the private drawing data and the shared drawing data are requested, the CPU 31 receives the private drawing data and the shared drawing data from the drawing data management server 11 through the external interface 35 (ACT 15).

After the private drawing data and the shared drawing data are received, the CPU 31 receives writing layer selection from the user through the operation unit 37 (ACT 16). That is, the CPU 31 receives selection of one of “private layer” and “shared layer” as the writing layer from the user.

After the writing layer selection is received from the user, the CPU 31 determines whether the user is performing writing on the page of the document (ACT 17). For example, the CPU 31 determines whether the user has touched the operation unit 37 to input characters. That is, the CPU 31 determines whether the user has touched the operation unit 37 to write the characters. Further, for example, this is similarly applied to a case where the browsing mode and the writing mode are prepared and the user changed the mode to the writing mode, and to a case where the user selects a pen. In addition, the CPU 31 similarly performs the determination of whether the user has touched the operation unit 37 to delete characters.

If it is determined that the user is performing the writing on the page of the document (ACT 17, YES), the CPU 31 sets the higher density (first density) for the image indicated by the drawing data corresponding to the writing layer (that is, drawing data of which the corresponding attribute information is the first attribute information), and sets the lower density (second density) (ACT 18) for the image indicated by the other drawing data (that is, drawing data of which the corresponding attribute information is attribute information (second attribute information) different from the first attribute information). Then, the CPU 31 displays the image indicated by the shared drawing data with the density set for the shared drawing data, and the image indicated by the private drawing data with the density set for the private drawing data on the page of the document (ACT 20).

If it is determined that the user does not perform the writing on the page of the document (ACT 17, NO), the CPU 31 sets the same density (default density, for example, first density) for the images indicated by the drawing data corresponding to all the writing layers (ACT 19). Then, the CPU 31 displays the image indicated by the shared drawing data with the density set for the shared drawing data, and displays the image indicated by the private drawing data with the density set for the private drawing data, on the page of the document (ACT 20).

After the image is displayed on the page of the document, the CPU 31 terminates the operation.

Before receiving the writing layer selection, the CPU 31 may display the image indicated by the drawing data on the page of the document. In this case, the CPU 31 may set the same density (default density, for example, first density) for both the private drawing data and the shared drawing data.

Further, the CPU 31 may operate to display the page of the document after receiving the drawing data.

The CPU 31 performs the operation of the user terminal 12 by executing a computer program in the RAM 32. The computer program is codes that cause a computer to achieve the various functions of the user terminal 12.

The user terminal having such a configuration may display the image indicated by the drawing data corresponding to the layer written by the user with a higher density, and may display the image indicated by the drawing data corresponding to another layer with a lower density. As a result, the user terminal may display the image of the writing layer and the image of another layer at the same time so as to be easily distinguished.

In the above described embodiment, a program for achieving the embodiment is stored in the apparatus in advance is described, but the embodiment is not limited thereto. Alternatively, the same program may be downloaded to the apparatus from a network, or the same program may be stored in a recording medium to be installed to the apparatus. The recording medium may be any type of recording medium that is capable of storing a program and is readable by the apparatus, such as a CD-ROM. Further, the functions obtained by such installation or downloading in advance may be achieved in cooperation with an operating system (OS) or the like in the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information display apparatus comprising:
a display unit configured to display a document page with a plurality of layers superimposed thereon, the plurality of layers including a first layer that includes a first image that is accessible by the information display apparatus and not by an apparatus external to the information display apparatus, and a second layer that includes a second image that is accessible by the information display apparatus and the apparatus external to the information display apparatus; and
a control unit configured to set one of the plurality of layers as a writing layer in which a user can add an image, and control the display unit such that a density of the first image is different from a density of the second image when the first layer is set as the writing layer.

2. The information display apparatus according to claim 1, further comprising:
an operation unit configured to receive a user input selecting one of the plurality of layers as the writing layer, wherein
the control unit sets one of the plurality of layers as the writing layer based on the user input.

3. The information display apparatus according to claim 1, wherein
the density of the first image is greater than the density of the second image when the first layer is set as the writing layer.

4. The information display apparatus according to claim 3, wherein
the density of the first image is the same as the density of the second image when neither the first layer nor the second layer is set as the writing layer.

5. The information display apparatus according to claim 4, wherein
the density of the second image when the first layer is set as the writing layer is the same as the density of the second image when neither the first layer nor the second layer is set as the writing layer.

6. The information display apparatus according to claim 4, wherein
the density of the second image is greater than the density of the first image when the second layer is set as the writing layer.

7. The information display apparatus according to claim 1, wherein
the control unit is configured to operate in a plurality of operational modes including a first mode and a second mode, in the first mode, the control unit controls the display unit such that the document page is displayed with both the first and second images, and
in the second mode, the control unit controls the display unit such that the document page is displayed with the first image and not with the second image.

8. The information display apparatus according to claim 7, wherein
the plurality of operational modes further includes a third mode, in which the control unit controls the display unit such that the document page is displayed with the second image and not with the first image.

9. A method for displaying information on an information display apparatus, the method comprising:
displaying a document page with a plurality of layers superimposed thereon, the plurality of layers including a first layer that includes a first image that is accessible by the information display apparatus and not by an apparatus external to the information display apparatus, and a second layer that includes a second image that is accessible by the information display apparatus and the apparatus external to the information display apparatus;
setting one of the plurality of layers as a writing layer in which a user can add an image; and
causing a density of the first image to be different from a density of the second image, when the first layer is set as the writing layer.

10. The method according to claim 9, further comprising:
receiving a user input selecting one of the plurality of layers as the writing layer, wherein
one of the plurality of layers is set as the writing layer based on the user input.

11. The method according to claim 9, wherein
the density of the first image is greater than the density of the second image when the first layer is set as the writing layer.

12. The method according to claim 11, further comprising:
causing the density of the first image to be the same as the density of the second image when neither the first layer nor the second layer is set as the writing layer.

13. The method according to claim 12, further comprising:
the density of the second image when the first layer is set as the writing layer is the same as the density of the second image when neither the first layer nor the second layer is set as the writing layer.

14. The method according to claim 12, further comprising:
causing the density of the second image to be greater than the density of the first image when the second layer is set as the writing layer.

15. The method according to claim 9, wherein the information display apparatus is operated in a plurality of operational modes including a first mode and a second mode,
in the first mode, the displaying of the document page with the plurality of layers is carried out,
the method further comprising:
in the second mode, displaying the document page with the first image and not with the second image.

16. The method according to claim 15, wherein the plurality of operational modes further includes a third mode, the method further comprising:
in the third mode, displaying the document page with the second image and not with the first image.

17. A non-transitory computer readable medium comprising a program that is executable in a computing device to cause the computing device to perform a method for displaying information on an information display apparatus, the method comprising:
displaying a document page with a plurality of layers superimposed thereon, the plurality of layers including a first layer that includes a first image that is accessible by the information display apparatus and not by an apparatus external to the information display apparatus, and a second layer that includes a second image that is accessible by the information display apparatus and the apparatus external to the information display apparatus;
setting one of the plurality of layers as a writing layer in which a user can add an image; and
causing a density of the first image to be different from a density of the second image, when the first layer is set as the writing layer.

18. The non-transitory computer readable medium according to claim 17, wherein the method further comprises:
receiving a user input selecting one of the plurality of layers as the writing layer, wherein
one of the plurality of layers is set as the writing layer based on the user input.

19. The non-transitory computer readable medium according to claim 17, wherein
the density of the first image is greater than the density of the second image when the first layer is set as the writing layer.

20. The non-transitory computer readable medium according to claim 19, wherein the method further comprises:
causing the density of the first image to be the same as the density of the second image when neither the first layer nor the second layer is set as the writing layer.
